(19) United States
(12) Patent Application Publication
(10) Pub. No.: US 2019/0070902 A1
(43) Pub. Date: Mar. 7, 2019

(54) NON-PNEUMATIC TIRE

(71) Applicant: TOYO TIRE & RUBBER CO., LTD., Itami-shi (JP)

(72) Inventor: Kohei Kajiwara, Itami-shi (JP)

(73) Assignee: TOYO TIRE & RUBBER CO., LTD., Itami-shi (JP)

(21) Appl. No.: 16/117,905

(22) Filed: Aug. 30, 2018

(30) Foreign Application Priority Data
Sep. 7, 2017 (JP) 2017-172034

(51) Int. Cl. B60C 7/10; B60C 7/18; B60B 9/12

(52) U.S. Cl. CPC B60C 7/102; B60C 2007/146; B60B 9/12; B60C 7/18

(57) ABSTRACT

In a non-pneumatic tire, at least one of a first connecting portions extends in such fashion as to be directed from one side in a tire width direction of an inner annular portion to the other side in a tire width direction of an outer annular portion, at least one of a second connecting portions extends in such fashion as to be directed from the other side in the tire width direction of the inner annular portion to the one side in the tire width direction of the outer annular portion, such that, the at least one second connecting portion appears to intersect the at least one first connecting portion, and that a maximum dimension in a tire radial direction of at least one of the closed spaces is greater than or equal to a maximum dimension in the tire width direction of the at least one closed space.

### CROSS REFERENCE TO RELATED APPLICATIONS

This application claims the benefit of priority of Japanese application no. 2017-172034, filed on Sep. 7, 2017, which is incorporated herein by reference.

### BACKGROUND OF THE INVENTION

### Field of the Invention

The present invention relates to a non-pneumatic tire provided with an inner annular portion and an outer annular portion that are arranged in concentric fashion, and connecting portions that connect the inner annular portion and the outer annular portion.

### Description of the Related Art

Conventionally known as a non-pneumatic tire is a non-pneumatic tire that is provided with an inner annular portion and an outer annular portion that are arranged in concentric fashion, and first and second connecting portions that connect the inner annular portion and the outer annular portion (e.g., Japanese Patent No. 6,099,519). At such a non-pneumatic tire, because the first connecting portion and the second connecting portion are arranged so as to appear to intersect as viewed in the tire circumferential direction, closed space(s) are formed between the first connecting portion and the second connecting portion.

In accordance with such constitution, presence of closed space(s) as viewed in the tire circumferential direction makes it possible to increase elasticity. It is therefore possible to improve performance with respect to ride comfort. However, if elasticity is made too high, because there will be a decrease in rigidity, this will result in lowered performance with respect to endurance.

### SUMMARY OF THE INVENTION

The problem is therefore to provide a non-pneumatic tire such as will make it possible to simultaneously achieve performance with respect to ride comfort and performance with respect to endurance.

There is provided a pneumatic tire, which includes:

an inner annular portion and an outer annular portion that are arranged in concentric fashion; and

a plurality of first connecting portions and a plurality of second connecting portions that are arrayed in alternating fashion in a tire circumferential direction and that connect the inner annular portion and the outer annular portion;

wherein the first and second connecting portions are formed so as to be planar and are arranged so as to face the tire circumferential direction;

at least one of the first connecting portions extends in such fashion as to be directed from one side in a tire width direction of the inner annular portion to the other side in the tire width direction of the outer annular portion;

at least one of the second connecting portions extends in such fashion as to be directed from the other side in the tire width direction of the inner annular portion to the one side in the tire width direction of the outer annular portion, such that, as viewed in the tire circumferential direction, the at least one second connecting portion appears to intersect the at least one first connecting portion in such fashion as to appear to cause formation of a pair of closed spaces between the at least one second connecting portion and the at least one first connecting portion; and

a maximum dimension in a tire radial direction of at least one of the closed spaces is greater than or equal to a maximum dimension in the tire width direction of the at least one closed space.

Further, the pneumatic tire may have a configuration in which:

endpoints at a location at which a dimension in the tire width direction of the at least one closed space achieves a maximum are arranged so as to be nearer to that annular portion, which of the inner annular portion and the outer annular portion is the nearer to the at least one closed space, than a center of the at least one closed space in the tire radial direction.

Further, the pneumatic tire may have a configuration in which:

the pair of closed spaces comprises an inner closed space toward an interior in the tire radial direction, and an outer closed space toward an exterior in the tire radial direction; and

endpoints at a location at which a dimension in the tire width direction of the inner closed space achieves a maximum are arranged so as to be nearer to the inner annular portion than a center of the inner closed space in the tire radial direction.

Further, the pneumatic tire may have a configuration in which:

the pair of closed spaces comprises an inner closed space toward an interior in the tire radial direction, and an outer closed space toward an exterior in the tire radial direction; and

endpoints at a location at which a dimension in the tire width direction of the outer closed space achieves a maximum are arranged so as to be nearer to the outer annular portion than a center of the outer closed space in the tire radial direction.

Further, the pneumatic tire may have a configuration in which:

the first and second connecting portions are provided with curved portions at locations that are disposed at end portions in the tire radial direction and that are disposed toward an interior in the tire width direction;

the curved portions have side edges that are curved in concave fashion as viewed in the tire circumferential direction; and

endpoints at a location at which a dimension in the tire width direction of the at least one closed space achieves a maximum are located partway along the curved portions in the tire radial direction.

Further, the pneumatic tire may have a configuration in which:

the first and second connecting portions are provided with linear portions at locations that are disposed at end portions in the tire radial direction and that are disposed toward an interior in the tire width direction;

the linear portions have side edges that are linear as viewed in the tire circumferential direction; and

the linear portions are arranged between the annular portions and the curved portions in such fashion as to be contiguous with the annular portions.

Further, the pneumatic tire may have a configuration in which:

at least one of the side edges of at least one of the linear portions is tangent to at least one of the side edges of at least one of the curved portions at a boundary between the at least one linear portion and the at least one curved portion.

Further, the pneumatic tire may have a configuration in which:

a first region at which at least one of the annular portions is contiguous with the first connecting portion and a second region at which the at least one annular portion is contiguous with the second connecting portion are arranged so as to appear to partially overlap as viewed in the tire circumferential direction.

Further, the pneumatic tire may have a configuration in which:

the maximum dimension in the tire width direction of the at least one closed space is 10% to 85% of the maximum dimension in the tire radial direction of the at least one closed space.

As described above, excellent benefits are provided in that a non-pneumatic tire is made capable of simultaneously achieving performance with respect to ride comfort and performance with respect to endurance.

### BRIEF DESCRIPTION OF DRAWINGS

FIG. 1 is a full front view of a non-pneumatic tire associated with an embodiment;

FIG. 2 is an enlarged view of region II in FIG. 1;

FIG. 3 is a is a sectional view, being a section taken along III-III in FIG. 2 as viewed in the tire circumferential direction;

FIG. 4 is an enlarged view of the principal components in FIG. 3;

FIG. 5 is a full view as viewed in the tire circumferential direction of a connecting portion associated with same embodiment;

FIG. 6 is an enlarged view as viewed in the tire circumferential direction of the principal components of a connecting portion associated with same embodiment; and

FIG. 7 is a table showing results of evaluation of examples and comparative examples.

### DETAILED DESCRIPTION OF THE INVENTION

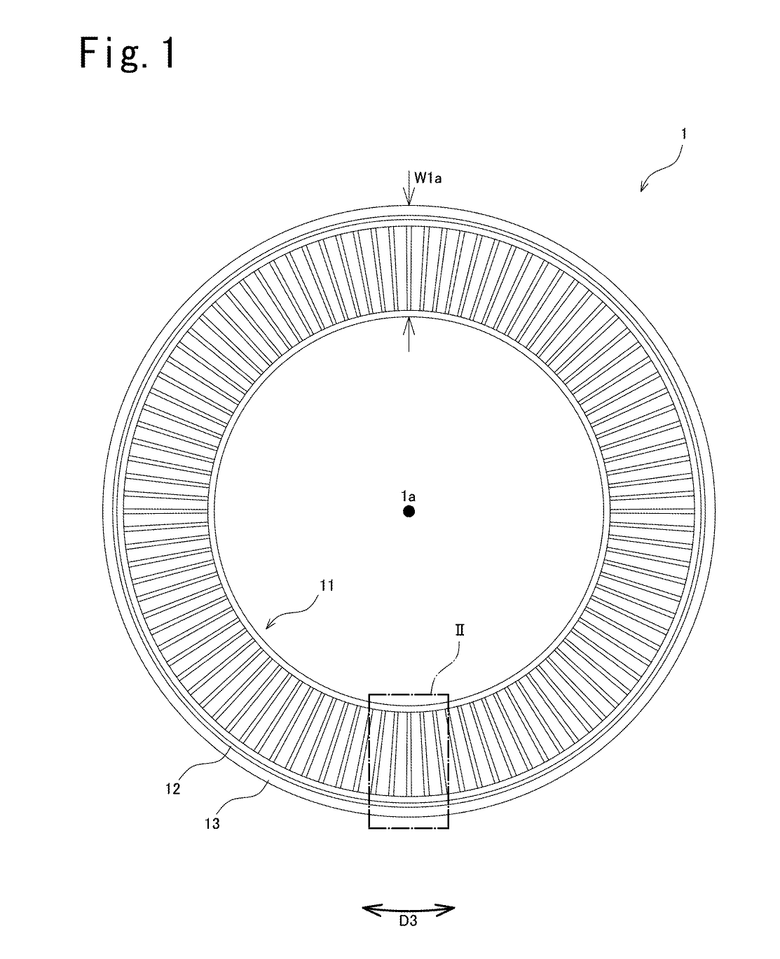

Below, an embodiment of a non-pneumatic tire (hereinafter also referred to simply as “tire”) is described with reference to FIG. 1 through FIG. 6. At the respective drawings, note that dimensional ratios in the drawings and actual dimensional ratios are not necessarily consistent, and note further that dimensional ratios are not necessarily consistent from drawing to drawing.

At the respective drawings, note also that first direction D1 is the tire width direction D1 which is parallel to axis 1a which is the rotational axis of the tire, second direction D2 is the tire radial direction D2 which is the direction of the diameter of the tire, and third direction D3 is the tire circumferential direction D3 which is the direction that is circumferential about axis 1a. Furthermore, tire equatorial plane S1 is a plane that is located centrally in the tire width direction D1 and that is perpendicular to axis 1a, and tire meridional planes are planes that are perpendicular to tire equatorial plane S1 and that contain axis 1a.

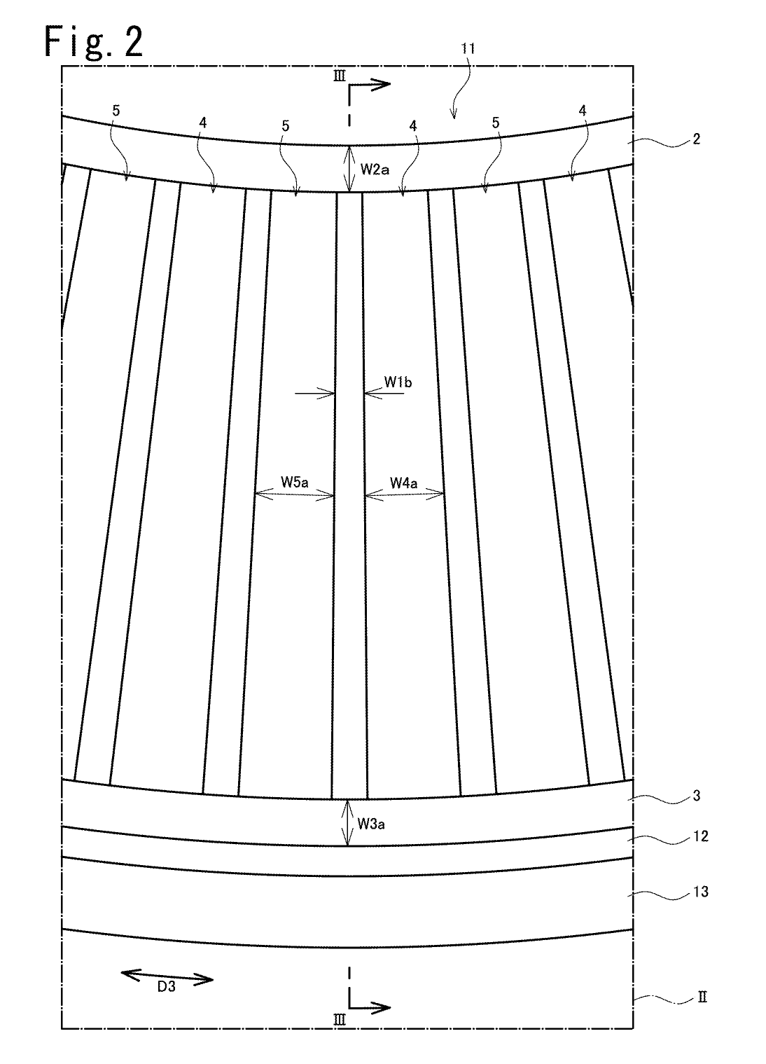

As shown in FIG. 1 and FIG. 2, tire 1 associated with present embodiment is provided with support structure 11 which supports the load from the vehicle. In addition, support structure 11 is provided with inner annular portion 2 and outer annular portion 3 which are arranged in concentric fashion, and a plurality of first connecting portions 4 and second connecting portions 5 which connect inner annular portion 2 and outer annular portion 3. Note that outer annular portion 3 is arranged at a location toward the exterior from inner annular portion 2 in such fashion that inner annular portion 2 is contained therewithin, connecting portions 4, 5 being arranged in the space between inner annular portion 2 and outer annular portion 3.

Furthermore, to reinforce support structure 11, tire 1 is provided with reinforcing layer 12 which is arranged at a location toward the exterior from support structure 11, and tread 13 which comes in contact with the ground and which is arranged at a location toward the exterior from reinforcing layer 12. Furthermore, while not shown in the drawings, tire 1 may be such that member(s), e.g., for accommodation of wheel hub(s) or rim(s), are provided at location(s) toward the interior from support structure 11.

Reinforcing layer 12 might, for example, be constituted such that steel cord(s), or CFRP, GFRP, or other such fiber-reinforced plastic cord(s) are arrayed in more or less parallel fashion with respect to the tire width direction D1, or from cylindrical metal ring(s), high-modulus resin ring(s), or the like. Furthermore, tread 13 might, for example, be constituted from rubber, resin, or the like in similar fashion as a conventional pneumatic tire, and may be provided with patterning (grooves) at the outer circumferential surface thereof in similar fashion as a conventional pneumatic tire.

It is preferred from the standpoint of improving uniformity with regard to weight balance that inner annular portion 2 be cylindrical and be of constant thickness. Furthermore, so as to allow it to be mounted on a wheel hub or rim, it is preferred that the inner circumferential surface of inner annular portion 2 be provided with intercuspation or the like for maintenance of engagement characteristics.

From the standpoint of ensuring improvement in weight reduction and endurance while permitting adequate transmission of force to connecting portions 4, 5, it is preferred that thickness (the dimension in the tire radial direction D2) W2a of inner annular portion 2 be 2% to 7% of tire cross-sectional height W1a, i.e., distance from the inner circumferential surface of inner annular portion 2 to the outer circumferential surface of tread 13 (i.e., to the outer circumferential surface of the tire 1), and it is more preferred that this be 3% to 6% thereof.

The inside diameter of inner annular portion 2 may be chosen as appropriate to accommodate the dimensions and so forth of the rim or wheel hub on which tire 1 is to be mounted. Note that where this is contemplated for use as a replacement for an ordinary pneumatic tire, 250 mm to 500 mm is preferred, and 330 mm to 440 mm is more preferred.

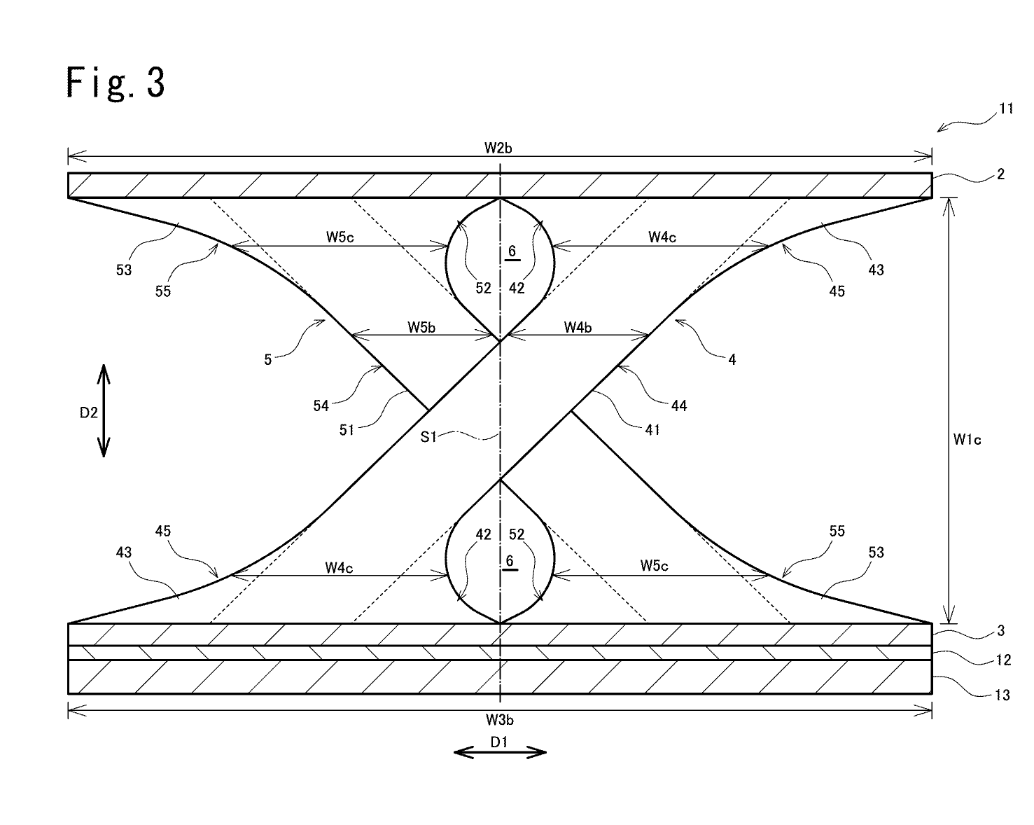

Width (the dimension in the tire width direction D1) W2b (see FIG. 3) of inner annular portion 2 may be chosen as appropriate in correspondence to the intended usage thereof, axle length, and so forth. Note that where this is contemplated for use as a replacement for an ordinary pneumatic tire, 100 mm to 300 mm is preferred, and 130 mm to 250 mm is more preferred.

It is preferred from the standpoint of improving uniformity with regard to weight balance that outer annular portion 3 be cylindrical and be of constant thickness. From the standpoint of ensuring improvement in weight reduction and endurance while permitting adequate transmission of force from connecting portions 4, 5, it is preferred that thickness (the dimension in the tire radial direction D2) W3a of outer annular portion 3 be 2% to 7% of tire cross-sectional height W1a, and it is more preferred that this be 2% to 5% thereof.

The inside diameter of outer annular portion 3 may be chosen as appropriate in correspondence to the intended usage thereof and so forth. Note that where this is contemplated for use as a replacement for an ordinary pneumatic tire, 420 mm to 750 mm is preferred, and 480 mm to 680 mm is more preferred.

Width (the dimension in the tire width direction D1) W3b (see FIG. 3) of outer annular portion 3 may be chosen as appropriate in correspondence to the intended usage thereof and so forth. Note that where this is contemplated for use as a replacement for an ordinary pneumatic tire, 100 mm to 300 mm is preferred, and 130 mm to 250 mm is more preferred. Furthermore, it is preferred that width W3b of outer annular portion 3 be the same as width W2b of inner annular portion 2.

Connecting portions 4, 5 are formed so as to be planar. In addition, connecting portions 4, 5 are arranged so as to face the tire circumferential direction D3. That is, connecting portions 4, 5 are arranged in parallel fashion with respect to both the tire width direction D1 and the tire radial direction D2. Stating this another way, connecting portions 4, 5 are arranged so as to lie in tire meridional planes. Note that the thickness direction of a connecting portion 4, 5 is in the direction of a tangent to the tire circumferential direction D3, and the width direction of connecting portions 4, 5 is the tire width direction D1.

A plurality of connecting portions 4, 5 are arrayed along the tire circumferential direction D3, being provided in respectively independent fashion so as to be spaced apart such that there are gaps therebetween. It is preferred from the standpoint of improving uniformity with regard to weight balance that gap W1b be constant. It is preferred that gap W1b be 0 mm to 10 mm, and more preferred that this be 0 mm to 5 mm. For example, if gap W1b is greater than 10 mm, this may cause nonuniformity in contact patch pressure and lead to an increase in noise.

Thicknesses W4a, W5a of connecting portions 4, 5 increase as one proceeds toward the exterior in the tire radial direction D2 (i.e., as one proceeds from inner annular portion 2 to outer annular portion 3). Note that a constitution may also be adopted in which thicknesses W4a, W5a of connecting portions 4, 5 are constant at all locations in the tire radial direction D2. From the standpoint of ensuring improvement in weight reduction and endurance while permitting adequate transmission of force from inner annular portion 2 and outer annular portion 3, it is preferred that thicknesses W4a, W5a of connecting portions 4, 5 be 8 mm to 30 mm, and it is more preferred that these be 10 mm to 20 mm.

Furthermore, from the standpoint of improving weight reduction and transmission of motive force, and of ensuring improvement in endurance, while permitting adequate support of the load from the vehicle, it is preferred that there be 80 to 300 of connecting portions 4, 5, and it is more preferred that there be 100 to 200 thereof. Note that tire 1 associated with FIG. 1 is provided with 100 connecting portions 4, 5.

As shown in FIG. 3, first connecting portion 4 extends in such fashion as to be directed from one side (the right side at FIG. 3) in the tire width direction D1 of inner annular portion 2 to the other side (the left side at FIG. 3) in the tire width direction D1 of outer annular portion 3. Second connecting portion 5 extends in such fashion as to be directed from the other side in the tire width direction D1 of inner annular portion 2 to the one side in the tire width direction D1 of outer annular portion 3.

Thus, as viewed in the tire circumferential direction D3, first connecting portion 4 and second connecting portion 5 extend so as to be inclined in mutually opposite directions. Moreover, first connecting portions 4 and second connecting portions 5 are arrayed in alternating fashion in the tire circumferential direction D3. This makes it possible to further reduce distribution of contact patch pressure during driving. Furthermore, as viewed in the tire circumferential direction D3, it is preferred that first connecting portions 4 and second connecting portions 5 be shaped so as to be symmetric with respect to the tire equatorial plane S1.

Connecting portions 4, 5 are provided with main body portions 41, 51, the widths (dimension in the tire width direction D1) of which are constant at all locations in the tire radial direction D2. Furthermore, to reinforce main body portions 41, 51, connecting portions 4, 5 are provided with inner reinforced portions 42, 52 at which connected is made to annular portions 2, 3 toward the interior in the tire width direction D1 from main body portions 41, 51, and outer reinforced portions 43, 53 at which connection is made to annular portions 2, 3 toward the exterior in the tire width direction D1 from main body portions 41, 51. At FIG. 3, note that boundaries between main body portions 41, 51 and reinforced portions 42, 43, 52, 53 are shown in broken line.

In addition, central portions 44, 54 in the tire radial direction D2 of connecting portions 4, 5 are made up of only main body portions 41, 51; end portions 45, 55 in the tire radial direction D2 of connecting portions 4, 5 are made up of main body portions 41, 51 and reinforced portions 42, 43, 52, 53. Because this makes it possible to reduce concentration of stress at end portions 45, 55 of connecting portions 4, 5, this makes it possible to improve endurance.

Furthermore, whereas widths (the dimension in the tire width direction D1) W4b, W5b of central portions 44, 54 of connecting portions 4, 5 are constant, widths (the dimension in the tire width direction D1) W4c, W5c of end portions 45, 55 of connecting portions 4, 5 gradually increase as one proceeds from central portions 44, 54 to annular portions 2, 3. Widths W4c, W5c of end portions 45, 55 of connecting portions 4, 5 are therefore greater than widths W4b, W5b of central portions 44, 54 of connecting portions 4, 5.

Inner reinforced portions 42, 52 are arranged so as to extend as far as the tire equatorial plane S1 from main body portions 41, 51. This being the case, end portion 45 of first connecting portion 4 and end portion 55 of second connecting portion 5 will be arranged so as to appear to partially overlap as viewed in the tire circumferential direction D3 (intended here to include not only the situation where there are overlapping region(s) but also the situation in which contact occurs).

It is in particular preferred that region(s) at which annular portions 2, 3 are contiguous with inner reinforced portions 42, 52 include the tire equatorial plane S1. Where this is the case, region(s) at which annular portions 2, 3 are contiguous with first connecting portion 4 and region(s) at which said annular portions 2, 3 are contiguous with second connecting portion 5 will be arranged so as to appear to partially overlap as viewed in the tire circumferential direction D3 (intended here to include not only the situation where there are overlapping region(s) but also the situation in which contact occurs).

More specifically, region(s) at which inner annular portion 2 is contiguous with first connecting portion 4 and region(s) at which inner annular portion 2 is contiguous with second connecting portion 5 are arranged so as to appear to partially overlap as viewed in the tire circumferential direction D3. Furthermore, region(s) at which outer annular portion 3 is contiguous with first connecting portion 4 and region(s) at which outer annular portion 3 is contiguous with second connecting portion 5 are arranged so as to appear to partially overlap as viewed in the tire circumferential direction D3.

Outer reinforced portions 43, 53 are arranged so as to extend as far as the ends in the tire width direction D1 of annular portions 2, 3 from main body portions 41, 51. Moreover, widths of inner reinforced portions 42, 52 and outer reinforced portions 43, 53 gradually increase as one proceeds from central portions 44, 54 to annular portions 2, 3. Furthermore, as viewed in the tire circumferential direction D3, the side edges of inner reinforced portions 42, 52 and outer reinforced portions 43, 53 are shaped so as to be concave.

Widths W4b, W4c, W5b, W5c of connecting portions 4, 5 are greater than thicknesses W4a, W5a of connecting portions 4, 5 (see FIG. 2). Moreover, the smallest width among widths W4b, W4c, W5b, W5c of connecting portions 4, 5 (i.e., widths W4b, W5b of central portions 44, 54) is larger than the largest thickness among thicknesses W4a, W5a of connecting portions 4, 5 (i.e., the thickness at the outermost end in the tire radial direction D2).

From the standpoint of reducing distribution of contact patch pressure while permitting improvement in endurance, it is preferred that widths W4b, W4c, W5b, W5c of connecting portions 4, 5 be not less than 110% of thicknesses W4a, W5a of connecting portions 4, 5, and it is more preferred that these be not less than 115% thereof. Furthermore, from the standpoint of ensuring improvement in weight reduction and endurance while permitting adequate transmission of force from inner annular portion 2 and outer annular portion 3, it is preferred that widths W4b, W4c, W5b, W5c of connecting portions 4, 5 be 5 mm to 25 mm, and it is more preferred that these be 10 mm to 20 mm.

Note that even where thicknesses W4a, W5a of connecting portions 4, 5 are made small, by choosing large widths W4b, W4c, W5b, W5c at connecting portions 4, 5 it will be possible to obtain the desired rigidity at connecting portions 4, 5. This will make it possible to improve endurance. Furthermore, even where thicknesses W4a, W5a are made small, by reducing the size(s) of gaps W1b between connecting portions 4, 5 and increasing the number of connecting portions 4, 5, it will be possible to maintain the rigidity of the overall tire 1. This will make it possible to reduce distribution of contact patch pressure during driving.

It will be noted that first connecting portion 4 and second connecting portion 5 appear to intersect as viewed in the tire circumferential direction D3. This causes formation between first connecting portion 4 and second connecting portion 5 of what appear to be closed space(s) 6 as viewed in the tire circumferential direction D3.

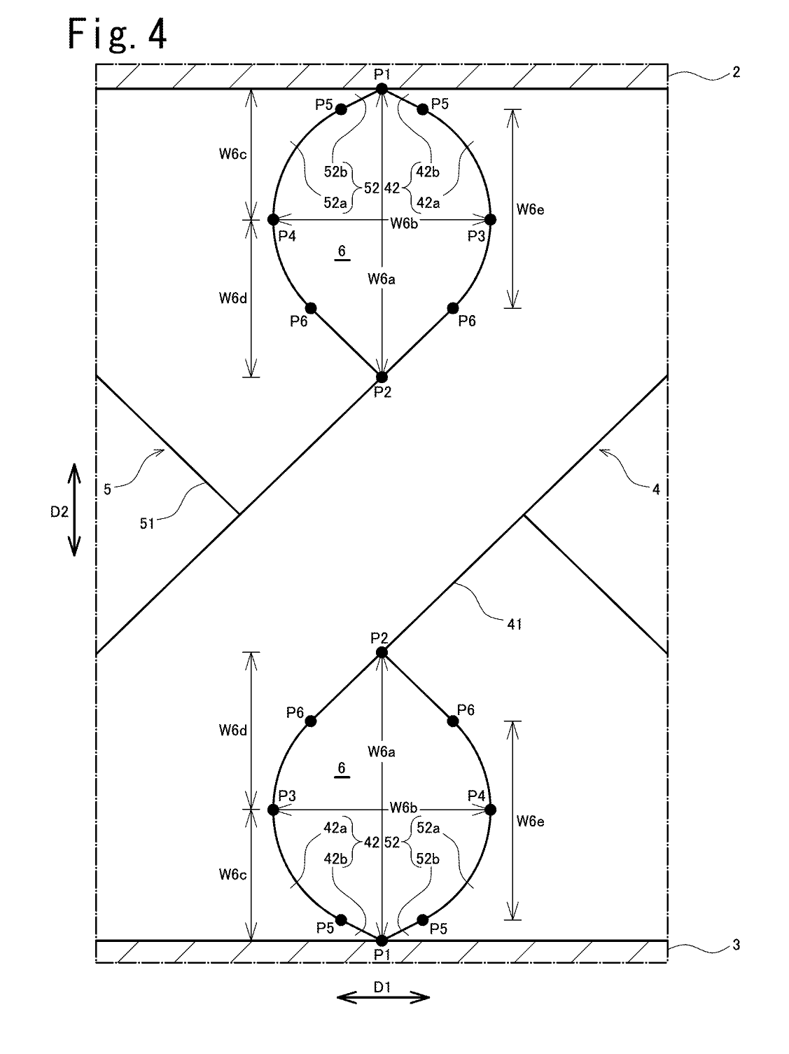

As shown in FIG. 4, the dimension in the tire radial direction D2 of closed space 6 achieves a maximum W6a at a location partway in the tire width direction D1 along said closed space 6, gradually decreasing from there as one proceeds toward either end in the tire width direction D1 of said closed space 6. Furthermore, the dimension in the tire width direction D1 of closed space 6 achieves a maximum W6b at a location partway in the tire radial direction D2 along said closed space 6, gradually decreasing from there as one proceeds toward either end in the tire radial direction D2 of said closed space 6.

At FIG. 4, point P1 is the endpoint (hereinafter also referred to as “first radial endpoint”) in the tire radial direction D2 of the closed space 6 which is nearer to that annular portion 2, 3 which of annular portion 2 and annular portion 3 is the nearer to said closed space 6, and point P2 is the endpoint (hereinafter also referred to as “second radial endpoint”) in the tire radial direction D2 of the closed space 6 which is nearer to the location at which first and second connecting portions 4, 5 intersect. This being the case, maximum dimension W6a in the tire radial direction D2 of closed space 6 is the distance in the tire radial direction D2 between first radial endpoint P1 and second radial endpoint P2.

Point P3 is the endpoint (hereinafter also referred to as “first width endpoint”) in the tire width direction D1 of closed space 6 which is on a side edge of first connecting portion 4, and point P4 is the endpoint (hereinafter also referred to as “second width endpoint”) in the tire width direction D1 of closed space 6 which is on a side edge of second connecting portion 5. This being the case, maximum dimension W6b in the tire width direction D1 of closed space 6 is the distance in the tire width direction D1 between first width endpoint P3 and second width endpoint P4.

In addition, to ensure simultaneous attainment of performance with respect to ride comfort and performance with respect to endurance, maximum dimension W6a in the tire radial direction D2 of closed space 6 is not less than maximum dimension W6b in the tire width direction D1 of closed space 6. It is, for example, preferred that maximum dimension W6b in the tire width direction D1 of closed space 6 be not less than 10% of maximum dimension W6a in the tire radial direction D2 of closed space 6, and it more preferred that this be not greater than 85% thereof. In addition, it is preferred that maximum dimension W6a in the tire radial direction D2 of closed space 6 be 20% to 45% of the distance W1c (see FIG. 3) between annular portions 2, 3.

Moreover, distance W6c in the tire radial direction D2 between width endpoints P3, P4 and first radial endpoint P1 is less than distance W6d in the tire radial direction D2 between width endpoints P3, P4 and second radial endpoint P2. This being the case, the locations P3, P4 at which the dimension in the tire width direction D1 of closed space 6 achieves a maximum W6b are arranged so as to be nearer to that annular portion 2, 3, which of annular portion 2 and annular portion 3 is the nearer to said closed space 6, than the location of the center of closed space 6 in the tire radial direction D2.

For example, at the closed space 6 which is toward the interior (toward the top in FIG. 4) in the tire radial direction D2, width endpoints P3, P4 are arranged so as to be nearer to that annular portion 2, which of annular portion 2 and annular portion 3 is the nearer to said closed space 6, i.e., inner annular portion 2, than the location of the center in the tire radial direction D2 of said closed space 6. Furthermore, at the closed space 6 which is toward the exterior (toward the bottom in FIG. 4) in the tire radial direction D2, width endpoints P3, P4 are arranged so as to be nearer to that annular portion 3, which of annular portion 2 and annular portion 3 is the nearer to said closed space 6, i.e., outer annular portion 3, than the location of the center in the tire radial direction D2 of said closed space 6.

Furthermore, inner reinforced portions 42, 52 of connecting portions 4, 5 are provided with curved portions 42a, 52a at which the side edges are curved in concave fashion as viewed in the tire circumferential direction D3, and linear portions 42b, 52b at which the side edges are linear as viewed in the tire circumferential direction D3. Linear portions 42b, 52b are contiguous with annular portions 2, 3, and curved portions 42a, 52a are arranged between linear portions 42b, 52b and main body portions 41, 51.

At FIG. 4, points P5 are points on the side edges of connecting portions 4, 5 at the boundaries between curved portions 42a, 52a and linear portions 42b, 52b, and points P6 are points on the side edges of connecting portions 4, 5 at the boundaries between inner reinforced portions 42, 52 and main body portions 41, 51. In addition, the locations at which the dimension in the tire width direction D1 of closed space 6 achieves a maximum W6b, i.e., width endpoints P3, P4, are locations partway along curved portions 42a, 52a, i.e., are locations other than the locations of the ends P5, P6 thereof, in the tire radial direction D2.

Moreover, when curved portion 42a, 52a is divided in the tire radial direction D2 into three equal regions, i.e., a central region and two end regions, it is preferred that width endpoints P3, P4 be arranged in the central region. Furthermore, it is preferred that dimension W6e in the tire radial direction D2 of curved portions 42a, 52a be not less than 50% of maximum dimension W6a in the tire radial direction D2 of said closed space 6.

It is preferred that the curves at the side edges of curved portions 42a, 52a be arcuate (i.e., elliptical arcs or circular arcs), and it is more preferred that these be arcs (i.e., circular arcs). In addition, as viewed in the tire circumferential direction D3, it is preferred that the side edges of linear portions 42b, 52b (be parallel to imaginary lines drawn) tangent to the side edges of curved portions 42a, 52a (at the boundaries between linear portions 42b, 52b and curved portions 42a, 52a), and it is preferred that the side edges of main body portions 41, 51 (be parallel to imaginary lines drawn) tangent to the side edges of curved portions 42a, 52a (at the boundaries between main body portions 41, 51 and curved portions 42a, 52a) Moreover, it is preferred that the radii of curvature at the side edges of curved portions 42a, 52a be 5 mm to 200 mm.

From the standpoint of ensuring improvement in weight reduction and endurance as well as mountability while permitting adequate transmission of force to connecting portions 4, 5, it is preferred that the tensile modulus of inner annular portion 2 be 5 MPa to 180,000 MPa, and it is more preferred that this be 7 MPa to 50,000 MPa. From the standpoint of ensuring improvement in weight reduction and endurance while permitting adequate transmission of force from connecting portions 4, 5, it is preferred that the tensile modulus of outer annular portion 3 be 5 MPa to 180,000 MPa, and it is more preferred that this be 7 MPa to 50,000 MPa.

From the standpoint of ensuring improvement in weight reduction and endurance as well as improvement in lateral rigidity while permitting adequate transmission of force from inner annular portion 2 and outer annular portion 3, it is preferred that the tensile modulus of connecting portions 4, 5 be 5 MPa to 180,000 MPa, and it is more preferred that this be 7 MPa to 50,000 MPa. Note that tensile modulus is the value calculated from the tensile stress that exists when elongation is 10% when tensile testing is carried out in accordance with JIS K7312.

In particular, from the standpoint of permitting suitable rigidity to be imparted while allowing adequate endurance to be obtained, it is preferred that the tensile modulus of inner annular portion 2, outer annular portion 3, and connecting portions 4, 5 be 5 MPa to 100 MPa, and it is more preferred that this be 7 MPa to 50 MPa. In addition, while inner annular portion 2, outer annular portion 3, and connecting portions 4, 5 may be formed from respectively different materials, from the standpoint of permitting integral molding it is preferred that the base material exclusive of reinforcing material be the same material.

As material(s) employed as base material(s), thermoplastic elastomers (e.g., polyester elastomers and polyolefin elastomers), crosslinked rubbers (e.g., natural rubbers and styrene-butadiene rubbers), and other resins (e.g., polyethylene resins and other such thermoplastic resins, and epoxy resins and other such thermosetting resins) may be cited as examples. Furthermore, as reinforcing material(s), continuous fibers, discontinuous fibers, woven fabrics, nonwoven fabrics, and other such reinforcing fibers may be cited as examples.

Constitution of tire 1 associated with the present embodiment is as described above; action of tire 1 associated with the present embodiment is described below.

(1) Because what appear to be closed space(s) 6 as viewed in the tire circumferential direction D3 are formed between first connecting portion 4 and second connecting portion 5, it is possible to increase the elasticity of support structure 11. This makes it possible to improve performance with respect to ride comfort.

(2) But note that if elasticity is too high, because deformation of connecting portions 4, 5 will be too large, this will result in lowered performance with respect to endurance. In addition, during driving, greater force is received in the tire radial direction D2 than in the tire width direction D1.

Maximum dimension W6a in the tire radial direction D2 of closed space 6 is therefore made to be not less than maximum dimension W6b in the tire width direction D1 of closed space 6. This makes it possible to suppress reduction in rigidity in the tire radial direction D2. Accordingly, it is possible to suppress reduction in performance with respect to endurance that might otherwise occur due to closed space 6.

(3) Furthermore, during deformation of support structure 11, at connecting portions 4, 5, a large amount of stress acts on the locations P3, P4 at which the dimension in the tire width direction D1 of closed space 6 achieves a maximum W6b, i.e., width endpoints P3, P4. This creates a tendency for connecting portions 4, 5 to fail in the regions surrounding width endpoints P3, P4.

Because rigidity of connecting portions 4, 5 is greater the nearer one is to the annular portion 2, 3 being supported thereby, width endpoints P3, P4 are therefore arranged so as to be nearer to that annular portion 2, 3, which of annular portion 2 and annular portion 3 is the nearer to closed space 6, than the location of the center of said closed space 6 in the tire radial direction D2. Because this causes width endpoints P3, P4 to be at locations along connecting portions 4, 5 where rigidity is high, this makes it possible to suppress reduction in performance with respect to endurance that might otherwise occur.

(4) Moreover, width endpoints P3, P4, are at locations partway along curved portions 42a, 52a in the tire radial direction D2. Because stresses tend to be better distributed at portions having curved side edges than at portions having linear side edges, this makes it possible for the large amount of stress that acts on width endpoints P3, P4 to be distributed over a larger region by curved portions 42a, 52a. Accordingly, it is possible to suppress reduction in performance with respect to endurance that might otherwise occur.

(5) Furthermore, during driving, at annular portions 2, 3, the greatest load in the tire radial direction D2 acts at a central location in the tire width direction D1. Region(s) at which annular portions 2, 3 are contiguous with first connecting portion 4 and region(s) at which said annular portions 2, 3 are contiguous with second connecting portion 5 are therefore arranged so as to appear to partially overlap as viewed in the tire circumferential direction D3. This being the case, central locations in the tire width direction D1 of inner annular portion 2 and outer annular portion 3 are supported by both first connecting portion 4 and second connecting portion 5. Accordingly, it is possible to suppress reduction in performance with respect to endurance that might otherwise occur.

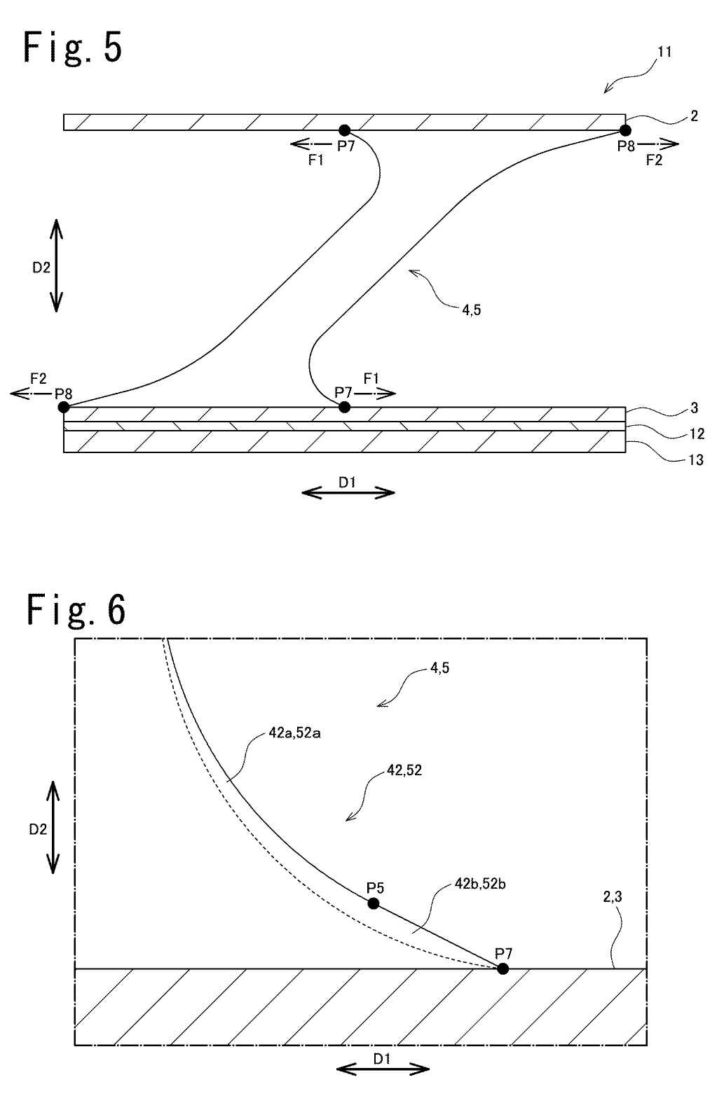

(6) Furthermore, as shown in FIG. 5, when a load acts in the tire radial direction D2, stresses F1, F2 having components in the tire width direction D1 act on annular portions 2, 3 from connecting portions 4, 5. As viewed in the tire circumferential direction D3, the directions of said stresses F1, F2 are tangent to the side edges of connecting portions 4, 5 at locations P7, P8 at either end along each of the boundaries at which annular portions 2, 3 make connection with connecting portions 4, 5.

In addition, because the side edges at said locations P7, P8 at the boundaries at which annular portions 2, 3 make connection with connecting portions 4, 5 are all formed so as to be concave, said stresses F1, F2 will act so as to be directed away from connecting portions 4, 5. At FIG. 5, note that the directions of those components of said stresses F1, F2 that act in the tire width direction D1 are indicated by the arrows which are drawn in alternating long and short chain line.

In this regard, in a constitution in which region(s) at which annular portions 2, 3 are contiguous with first connecting portion 4 and region(s) at which said annular portions 2, 3 are contiguous with second connecting portion 5 are arranged so as to appear to be separated as viewed in the tire circumferential direction D3, stresses F1, F1 respectively acting thereon from locations P7, P7 at end toward the interior in the tire width direction D1 of first and second connecting portions 4, 5 will be concentrated at central locations in the tire width direction D1 of annular portions 2, 3. This being the case, it is possible that buckling of annular portions 2, 3 might occur at central location(s) in the tire width direction D1.

Regions at which annular portions 2, 3 are contiguous with first connecting portion 4 and regions at which said annular portions 2, 3 are contiguous with second connecting portion 5 are therefore arranged so as to appear to partially overlap as viewed in the tire circumferential direction D3. This causes stresses F1, F1 respectively acting thereon from locations P7, P7 at ends toward the interior in the tire width direction D1 of first and second connecting portions 4, 5 to be distributed from central locations in the tire width direction D1 of annular portions 2, 3. Accordingly, it is possible to suppress reduction in performance with respect to endurance that might otherwise occur.

(7) Furthermore, as indicated by the dashed line at FIG. 6, where connection is made to annular portions 2, 3 by way of concavely curved side edges at connecting portions 4, 5, this will cause the volumes of the regions at connecting portions 4, 5 in the vicinities of the locations at which connection is made to annular portions 2, 3 to be small. Linear portions 42b, 52b are therefore arranged between annular portions 2, 3 and curved portions 42a, 52a so as to cause connection to be made to annular portions 2, 3 by way of linear side edges at connecting portions 4, 5.

Because this causes the volumes of the regions at connecting portions 4, 5 in the vicinities of the locations at which connection is made to annular portions 2, 3 to be large, this makes it possible to increase rigidity at end portions 45, 55 of connecting portions 4, 5. Accordingly, it is possible to suppress reduction in performance with respect to endurance that might otherwise occur.

As described above, the non-pneumatic tire 1 of the embodiment include an inner annular portion 2 and an outer annular portion 3 that are arranged in concentric fashion, and a plurality of first connecting portions 4 and a plurality of second connecting portions 5 that are arrayed in alternating fashion in a tire circumferential direction D3 and that connect the inner annular portion 2 and the outer annular portion 3, wherein the first and second connecting portions 4, 5 are formed so as to be planar and are arranged so as to face the tire circumferential direction D3, at least one of the first connecting portions extends in such fashion as to be directed from one side in a tire width direction D1 of the inner annular portion 2 to the other side in the tire width direction D1 of the outer annular portion 3, at least one of the second connecting portions extends in such fashion as to be directed from the other side in the tire width direction D1 of the inner annular portion 2 to the one side in the tire width direction D1 of the outer annular portion 3, such that, as viewed in the tire circumferential direction D3, the at least one second connecting portion appears to intersect the at least one first connecting portion in such fashion as to appear to cause formation of a pair of closed spaces 6, 6 between the at least one second connecting portion 5 and the at least one first connecting portion 4, and a maximum dimension W6a in a tire radial direction D2 of at least one of the closed spaces 6 is greater than or equal to a maximum dimension W6b in the tire width direction D1 of the at least one closed space 6.

In accordance with such constitution, as viewed in the tire circumferential direction D3, because first connecting portion 4 and second connecting portion 5 intersect, a pair of closed spaces 6, 6 are formed between first connecting portion 4 and second connecting portion 5. This makes it possible to increase elasticity. In addition, because maximum dimension W6a in the tire radial direction D2 of closed space 6 is not less than maximum dimension W6b in the tire width direction D1 of closed space 6, it is possible to suppress reduction in rigidity in the tire radial direction D2. This makes it possible to ensure simultaneous attainment of performance with respect to ride comfort and performance with respect to endurance.

In the non-pneumatic tire 1 of the embodiment, endpoints at a location P3, P4 at which a dimension in the tire width direction D1 of the at least one closed space 6 achieves a maximum are arranged so as to be nearer to that annular portion 2, 3, which of the inner annular portion 2 and the outer annular portion 3 is the nearer to the at least one closed space 6, than a center of the at least one closed space 6 in the tire radial direction D2.

In accordance with such constitution, during deformation, large stresses act on first and second connecting portions 4, 5 at locations at which the dimension in the tire width direction D1 of closed space 6 achieves a maximum W6b. But rigidity of first and second connecting portions 4, 5 is greater the nearer one is to the annular portion 2, 3 being supported thereby.

The locations P3, P4 at which the dimension in the tire width direction D1 of closed space 6 achieves a maximum W6b are therefore arranged so as to be nearer to that annular portion 2, 3, which of annular portion 2 and annular portion 3 is the nearer to said closed space 6, than the location of the center of closed space 6 in the tire radial direction D2. This causes said locations P3, P4 to be located where rigidity is large along first and second connecting portions 4, 5.

In the non-pneumatic tire 1 of the embodiment, the first and second connecting portions 4, 5 are provided with curved portions 42a, 52a at locations that are disposed at end portions 45, 55 in the tire radial direction D2 and that are disposed toward an interior in the tire width direction D1, the curved portions 42a, 52a have side edges that are curved in concave fashion as viewed in the tire circumferential direction D3, and endpoints at a location P3, P4 at which a dimension W6b in the tire width direction D1 of the at least one closed space 6 achieves a maximum are located partway along the curved portions 42a, 52a in the tire radial direction D2.

In accordance with such constitution, at locations toward the interior in the tire width direction D1 of end portions 45, 55, first and second connecting portions 4, 5 are provided with curved portions 42a, 52a at which the side edges are curved as viewed in the tire circumferential direction D3. In addition, whereas the locations at which large stresses act during deformation are the locations P3, P4 at which the dimension in the tire width direction D1 of closed space 6 achieves a maximum W6b, said locations P3, P4 are located partway along curved portions 42a, 52a in the tire radial direction D2. This being the case, the large stresses which act during deformation to be distributed by curved portions 42a, 52a.

In the non-pneumatic tire 1 of the embodiment, a first region at which at least one of the annular portions 2, 3 is contiguous with the first connecting portion 4 and a second region at which the at least one annular portion 2, 3 is contiguous with the second connecting portion 5 are arranged so as to appear to partially overlap as viewed in the tire circumferential direction D3.

In accordance with such constitution, whereas the location at which the greatest load acts on annular portions 2, 3 during driving is the central location in the tire width direction D1, region(s) at which annular portions 2, 3 are contiguous with first connecting portion 4 and region(s) at which said annular portions 2, 3 are contiguous with second connecting portion 5 are arranged so as to appear to partially overlap as viewed in the tire circumferential direction D3. This being the case, the central location in the tire width direction D1 of annular portions 2, 3 is supported by both the first and second connecting portions 4, 5.

The non-pneumatic tire 1 is not limited to the configuration of the embodiment described above, and the effects are not limited to those described above. It goes without saying that the non-pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of non-pneumatic tire 1 associated with the foregoing embodiment is such that connecting portions 4, 5 are provided with main body portions 41, 51 and reinforced portions 42, 43, 52, 53. However, non-pneumatic tire 1 is not limited to such constitution. For example, it is also possible to adopt a constitution in which connecting portions 4, 5 are not provided with reinforced portions 42, 43, 52, 53, and in which the dimension in the tire width direction D1 of connecting portions 4, 5 is constant at all locations in the tire radial direction D2.

(2) Furthermore, the constitution of non-pneumatic tire 1 associated with the foregoing embodiment is such that locations P3, P4 at which the dimension in the tire width direction D1 of closed space 6 achieves a maximum W6b are arranged so as to be nearer to that annular portion 2, 3, which of annular portion 2 and annular portion 3 is the nearer to said closed space 6, than the location of the center of closed space 6 in the tire radial direction D2. However, non-pneumatic tire 1 is not limited to such constitution. For example, it is also possible to adopt a constitution in which said locations P3, P4 at closed space 6 are arranged so as to be nearer to the location at which first and second connecting portions 4, 5 intersect (the location of the center in the tire radial direction D2 between annular portions 2, 3) than the location of the center of closed space 6 in the tire radial direction D2.

(3) Furthermore, the constitution of non-pneumatic tire 1 associated with the foregoing embodiment is such that locations P3, P4 at which the dimension in the tire width direction D1 of closed space 6 achieves a maximum W6b are located partway along curved portions 42a, 52a in the tire radial direction D2. However, non-pneumatic tire 1 is not limited to such constitution. For example, it is also possible to adopt a constitution in which said locations P3, P4 are the locations of the ends P5, P6 of curved portions 42a, 52a in the tire radial direction D2. Furthermore, it is also possible, for example, to adopt a constitution in which said locations P3, P4 are located at portions of connecting portions 4, 5 at which the side edges are linear as viewed in the tire circumferential direction D3.

(4) Furthermore, the constitution of non-pneumatic tire 1 associated with the foregoing embodiment is such that regions at which annular portions 2, 3 are contiguous with first connecting portion 4 and regions at which said annular portions 2, 3 are contiguous with second connecting portion 5 are arranged so as to appear to partially overlap as viewed in the tire circumferential direction D3. However, non-pneumatic tire 1 is not limited to such constitution. For example, it is also possible to adopt a constitution in which regions at which annular portions 2, 3 are contiguous with first connecting portion 4 and regions at which said annular portions 2, 3 are contiguous with second connecting portion 5 are arranged so as to appear to be separated as viewed in the tire circumferential direction D3.

### EXAMPLES

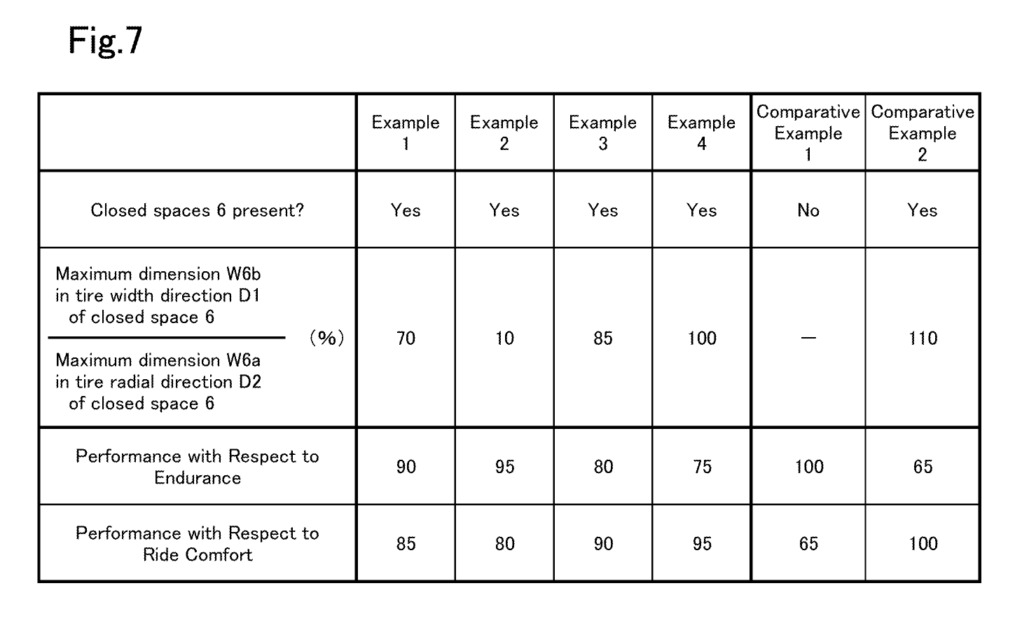

To illustrate the constitution and effect of the non-pneumatic tire in specific terms, examples of the non-pneumatic tire as well as comparative examples thereof are described below with reference to FIG. 7.

<Performance with Respect to Endurance>

Following FMVSS109 and using a drum-type testing machine, test speed was constant at 80 km/hr, running distance to cause failure being measured as load was increased in gradual fashion in four stages. Results are shown as indexed relative to a value of 100 for the running distance at Comparative Example 1, the larger the index the more excellent the performance with respect to endurance.

<Performance with Respect to Ride Comfort>

Overall sensory evaluation of ride comfort while driving along a test course was carried out by two vehicle occupants. More specifically, sensory evaluation of the magnitude of the vertical jerking motion directly felt by the bodies of vehicle occupants was carried out, the larger the vertical jerking motion felt the worse the evaluation received. Results are shown as indexed relative to a value of 100 for the evaluation received at Comparative Example 2, the larger the index the more excellent the performance with respect to ride comfort.

### Examples 1 to 4

Example 1 was a non-pneumatic tire for which maximum dimension W6b in the tire width direction D1 of closed space 6 was 70% of maximum dimension W6a in the tire radial direction D2 of closed space 6.

Example 2 was a non-pneumatic tire for which maximum dimension W6b in the tire width direction D1 of closed space 6 was 10% of maximum dimension W6a in the tire radial direction D2 of closed space 6.

Example 3 was a non-pneumatic tire for which maximum dimension W6b in the tire width direction D1 of closed space 6 was 85% of maximum dimension W6a in the tire radial direction D2 of closed space 6.

Example 4 was a non-pneumatic tire for which maximum dimension W6b in the tire width direction D1 of closed space 6 was 100% of maximum dimension W6a in the tire radial direction D2 of closed space 6.

### Comparative Examples 1 and 2

Comparative Example 1 was a non-pneumatic tire at which no closed space 6 was present.

Comparative Example 2 was a non-pneumatic tire for which maximum dimension W6b in the tire width direction D1 of closed space 6 was 110% of maximum dimension W6a in the tire radial direction D2 of closed space 6.

Note that the non-pneumatic tires associated with Examples 2 through 4 and Comparative Examples 1 and 2 were such that main body portions 41, 51 at connecting portions 4, 5 were of the same shape as those at the non-pneumatic tire associated with Example 1, the shape of closed space 6 being altered relative thereto as a result of alteration of the shape of inner reinforced portions 42, 52. Note that in all respects other than connecting portions 4, 5 the constitutions of the non-pneumatic tires associated with Examples 1 through 4 and Comparative Examples 1 and 2 were identical.

<Results of Evaluation>

As shown in FIG. 7, at Comparative Example 1, while performance with respect to endurance was excellent, performance with respect to ride comfort was extremely inferior, being 70 or less. Furthermore, at Comparative Example 2, while performance with respect to ride comfort was excellent, endurance was extremely inferior, being 70 or less. Accordingly, neither Comparative Example 1 nor Comparative Example 2 functions satisfactorily as a tire.

In contradistinction hereto, at Examples 1 through 4, while performance with respect to endurance was inferior to that of Comparative Example 1, a level of 70 or better was maintained; and while performance with respect to ride comfort was inferior to that of Comparative Example 2, a level of 70 or better was maintained. Accordingly, by causing maximum dimension W6a in the tire radial direction D2 of closed space 6 to be not less than maximum dimension W6b in the tire width direction D1 of closed space 6, it was possible to simultaneously achieve performance with respect to endurance and performance with respect to ride comfort.

Furthermore, a preferred example of a non-pneumatic tire is described below.

Although not the case at Example 4, levels of 80 or better were maintained for both performance with respect to endurance and performance with respect to ride comfort at Examples 1 through 3. Accordingly, because it was possible to simultaneously achieve performance with respect to endurance and performance with respect to ride comfort to an even greater degree by causing maximum dimension W6b in the tire width direction D1 of closed space 6 to be 10% to 85% of maximum dimension W6a in the tire radial direction D2 of closed space 6, this is preferred.

What is claimed is:

1. A non-pneumatic tire comprising:
an inner annular portion and an outer annular portion that are arranged in concentric fashion; and
a plurality of first connecting portions and a plurality of second connecting portions that are arrayed in alternating fashion in a tire circumferential direction and that connect the inner annular portion and the outer annular portion;
wherein the first and second connecting portions are formed so as to be planar and are arranged so as to face the tire circumferential direction;
at least one of the first connecting portions extends in such fashion as to be directed from one side in a tire width direction of the inner annular portion to the other side in the tire width direction of the outer annular portion;
at least one of the second connecting portions extends in such fashion as to be directed from the other side in the tire width direction of the inner annular portion to the one side in the tire width direction of the outer annular portion, such that, as viewed in the tire circumferential direction, the at least one second connecting portion appears to intersect the at least one first connecting portion in such fashion as to appear to cause formation of a pair of closed spaces between the at least one second connecting portion and the at least one first connecting portion; and
a maximum dimension in a tire radial direction of at least one of the closed spaces is greater than or equal to a maximum dimension in the tire width direction of the at least one closed space.

2. The non-pneumatic tire according to claim 1 wherein
endpoints at a location at which a dimension in the tire width direction of the at least one closed space achieves a maximum are arranged so as to be nearer to that annular portion, which of the inner annular portion and the outer annular portion is the nearer to the at least one closed space, than a center of the at least one closed space in the tire radial direction.

3. The non-pneumatic tire according to claim 1 wherein
the pair of closed spaces comprises an inner closed space toward an interior in the tire radial direction, and an outer closed space toward an exterior in the tire radial direction; and
endpoints at a location at which a dimension in the tire width direction of the inner closed space achieves a maximum are arranged so as to be nearer to the inner annular portion than a center of the inner closed space in the tire radial direction.

4. The non-pneumatic tire according to claim 1 wherein
the pair of closed spaces comprises an inner closed space toward an interior in the tire radial direction, and an outer closed space toward an exterior in the tire radial direction; and
endpoints at a location at which a dimension in the tire width direction of the outer closed space achieves a maximum are arranged so as to be nearer to the outer annular portion than a center of the outer closed space in the tire radial direction.

5. The non-pneumatic tire according to claim 1 wherein
the first and second connecting portions are provided with curved portions at locations that are disposed at end portions in the tire radial direction and that are disposed toward an interior in the tire width direction;
the curved portions have side edges that are curved in concave fashion as viewed in the tire circumferential direction; and
endpoints at a location at which a dimension in the tire width direction of the at least one closed space achieves a maximum are located partway along the curved portions in the tire radial direction.

6. The non-pneumatic tire according to claim 5 wherein
the first and second connecting portions are provided with linear portions at locations that are disposed at end portions in the tire radial direction and that are disposed toward an interior in the tire width direction;
the linear portions have side edges that are linear as viewed in the tire circumferential direction; and
the linear portions are arranged between the annular portions and the curved portions in such fashion as to be contiguous with the annular portions.

7. The non-pneumatic tire according to claim 6 wherein
at least one of the side edges of at least one of the linear portions is tangent to at least one of the side edges of at least one of the curved portions at a boundary between the at least one linear portion and the at least one curved portion.

8. The non-pneumatic tire according to claim 1 wherein
a first region at which at least one of the annular portions is contiguous with the first connecting portion and a second region at which the at least one annular portion is contiguous with the second connecting portion are arranged so as to appear to partially overlap as viewed in the tire circumferential direction.

9. The non-pneumatic tire according to claim 1 wherein
the maximum dimension in the tire width direction of the at least one closed space is 10% to 85% of the maximum dimension in the tire radial direction of the at least one closed space.
